(19) United States
(12) Patent Application Publication
(10) Pub. No.: US 2025/0332736 A1
(43) Pub. Date: Oct. 30, 2025

(54) BAR MATERIAL AUTOMATIC LABELING METHOD AND THE SYSTEM THEREOF

(71) Applicant: INDUSTRIAL TECHNOLOGY RESEARCH INSTITUTE, Hsinchu (TW)

(72) Inventors: MING-CHIEH HSIEH, Nantou County (TW); JING-BO CHEN, Taipei City (TW); SHUN-FU WU, Nantou County (TW)

(21) Appl. No.: 18/644,165

(22) Filed: Apr. 24, 2024

(51) Int. Cl. B25J 11/00; B05B 13/04; B25J 9/16

(52) U.S. Cl. CPC B25J 11/0085; B05B 13/0431; B25J 9/1697; B25J 11/0075

(57) ABSTRACT

A bar material automatic labeling method is adapted to build in a software program and executes the following steps after read by a central control system: detecting at least one bar material entering a detection range by a positioning module; performing positioning detection on a labeled surface of the bar material by the positioning module, and sending a detection result to the central control system for analysis; controlling a motion module to drive a cleaning module to clean the labeled surface by the central control system according to the detection result; and controlling the motion module to drive a nozzle of a labeling module to label the labeled surface by the central control system according to the detection result.

### TECHNICAL FIELD

The present disclosure relates to the field of material production technology, and in particular, to a method of automatically labeling data on the end face of materials and a system for executing the method.

### BACKGROUND

Steel bar or steel rod is a widely used commodity in the steel industry, and its production process involves multiple key steps to ensure that the product meets specific specifications and quality standards. Since there are many types of steel bars, and it is difficult to identify products with different carbon content ratios and manufacturing processes, it is necessary to spray paint and label after thermal processing to facilitate inquiries in the later stages of the process.

After the initially purchased steel raw material (usually carbon steel bar) is cut, it needs to be heated before being fed into the processing machine to improve its plasticity. Typically, steel needs to be heated to at least 1,000 degrees Celsius before it becomes softer and easier to work with. The heated steel is fed into processing machines such as hot rolling presses or stretching machines, and rolled and stretched through rollers or dies to form steel bars of specified shapes and sizes. As mentioned above, due to the very high temperature of thermal processing and molding operations, the working environment temperature can reach 85 to 100 degrees Celsius, posing extremely high risks to workers.

After hot processing and forming, labeling is made on the steel bar, such as identification model, size specifications, carbon content ratio, etc., so as to facilitate other processes in the later stages to query information about the steel bar. Since the temperature of the steel bar after hot processing is still high, the steel bar must be cooled to an appropriate temperature before labeling can be carried out.

Regarding the cooling process, the current practice is for workers to use large machines to transport high-temperature steel embryos to designated locations for cooling. After the temperature drops slightly, continuous spraying is carried out through powerful water jets to reduce the temperature of the steel embryos. Not only does it take a lot of labor and time, but the steel bars are easily deformed during transportation.

However, even after the above cooling steps, the temperature of the steel embryo is still as high as 400 to 600 degrees Celsius. After the working personnel spray-prints the paint used for labeling on the surface of the steel embryo, it is very easy for the paint to peel off, causing Identification to be difficult, and labeling errors are prone to occur in working environments where workers are exposed to high temperature risks.

In addition, the steel is hot-processed into a steel embryo and then exposed to cold air, resulting in the appearance of rust on the surface of the steel embryo. If the rust is not removed, the working personnel will label the rust on the surface of the steel embryo, and then the transportation of the post-processing process causes the rust to peel off, which also made it impossible to identify the labeled content.

In addition, the thickness of the paint used for labeling will also affect the adhesion of the labeling. Low-concentration paints are not suitable for adhering to high-temperature steel bars, while high-concentration paints not only increase costs but must be continuously stirred, otherwise they will easily solidify and cause nozzle blockage, which will take time to clean the nozzles and cause process delays.

In summary, the current problems of the steel bar process mainly include: the temperature of the hot-processed steel bar is too high and is not suitable for operation, multiple processes require partial cooling of the steel bar before printing and labeling can be carried out, rust peeling causes difficulty in labeling and identification, and low-concentration paint is not suitable to attach high-temperature steel bars and require extra manpower for printing and large-scale machinery to transport the steel bars. The steel bars will be severely deformed due to thermal expansion and contraction during transportation after thermal processing, and the production information of the steel bars cannot be recorded or transmitted in real time.

Accordingly, how to develop an “automatic material labeling method” that can overcome the labeling failure, labor costs, process costs and other deficiencies derived from the conventional spray printing labeling of the end face of steel bars is an urgent subject that needs for people in the relevant technical field to solve.

### SUMMARY

The present disclosure proposes a bar material automatic labeling method, adapted to build in a software program and executing the following steps after read by a central control system: detecting at least one material entering a detection range by a positioning module; performing positioning detection on a labeled surface of the material by the positioning module, and sending a detection result to the central control system for analysis; controlling a motion module to drive a cleaning module to clean the labeled surface by the central control system according to the detection result; and controlling the motion module to drive a nozzle of a labeling module to label the labeled surface by the central control system according to the detection result.

Furthermore, the present disclosure also proposes a system adapted to store and execute the bar material automatic labeling method as mentioned above.

### BRIEF DESCRIPTION OF THE DRA WINGS

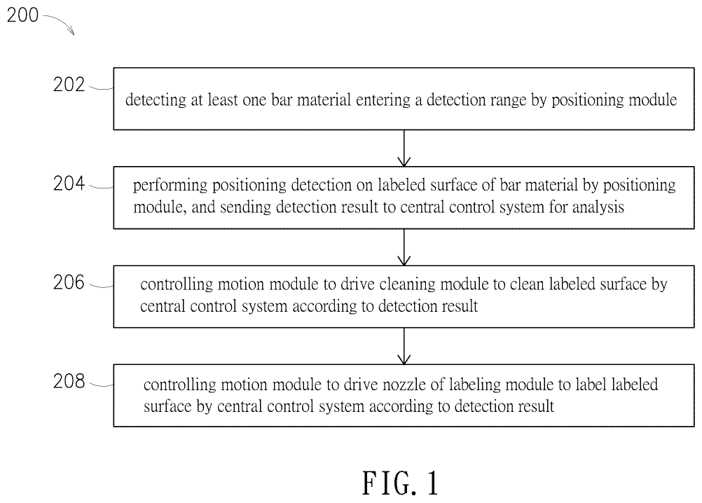

FIG. 1 is a flow chart of an embodiment of a bar material automatic labeling method of the present disclosure;

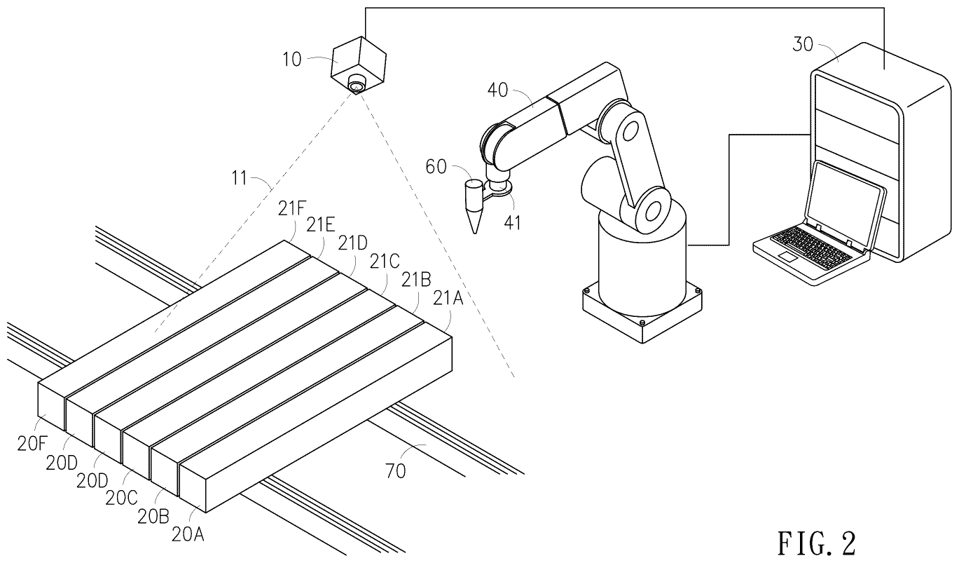

FIG. 2 is a diagram of a system structure of an embodiment of a bar material automatic labeling method of the present disclosure;

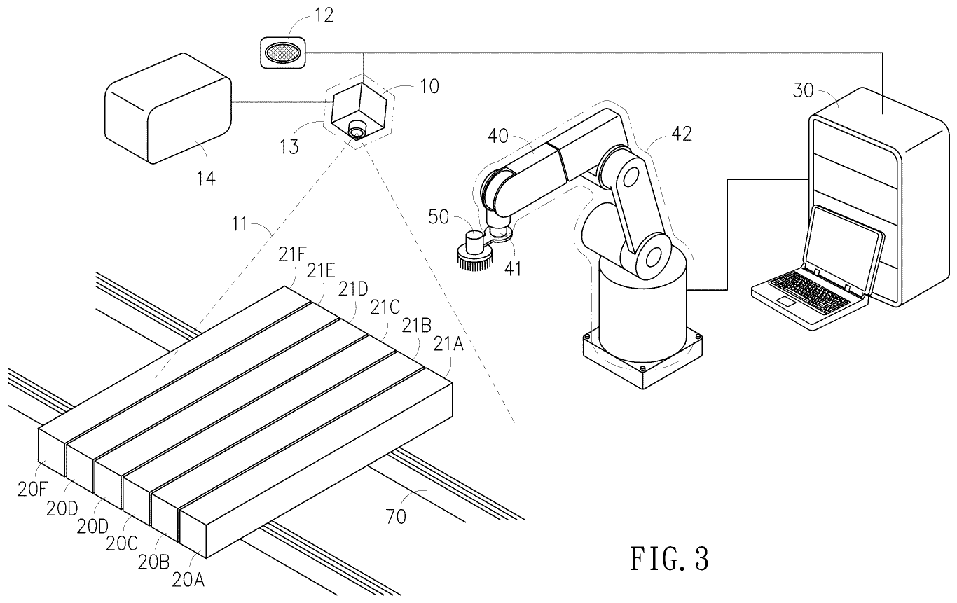

FIG. 3 is a diagram of a system structure of another embodiment of a bar material automatic labeling method of the present disclosure;

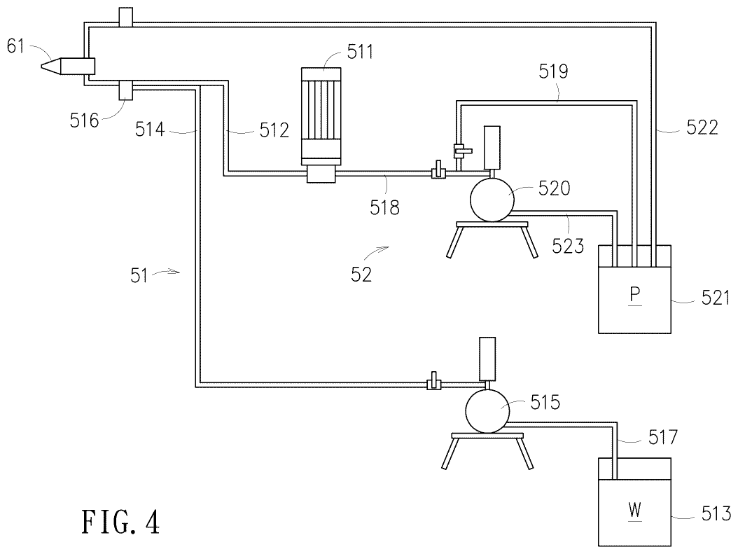

FIG. 4 is a diagram of a system structure of a nozzle and a nozzle cleaning assembly of a bar material automatic labeling method of the present disclosure; and

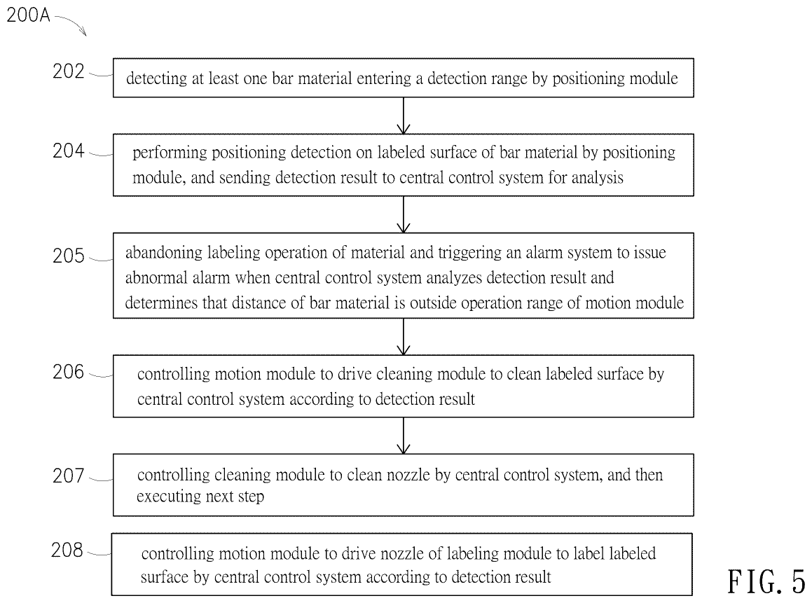

FIG. 5 is a flow chart of another embodiment of a bar material automatic labeling method of the present disclosure.

### DETAILED DESCRIPTION

Referring to FIG. 1, a process 200 of a bar material automatic labeling method of the present disclosure is adapted to build in a software program, and stored in a storage drive of a computer, and after this software program is read by a processor of this computer, the following steps 202 to 208 are executed. Referring to FIGS. 1 to 4, the process of a bar material automatic labeling method is described.

It is worth explaining that the materials mentioned in the present disclosure, such as steel bars, steel material and other bar raw materials, are still very high in temperature after thermal processing and forming, and are not suitable for manual labeling operations. Therefore, using the bar material automatic labeling method provided by the present disclosure, high-temperature materials can be fully automated labeling operations, so as to avoid harm to on-site workers and improve the accuracy of operations.

Referring to FIGS. 1 to 3, in step 202, a positioning module 10 is used to detect that a plurality of bar materials 20A to 20F are transported into a detection range 11.

As shown in FIG. 2, the bar materials 20A to 20F are sent into the detection range 11 through a conveyor belt 70.

As shown in FIGS. 2 and 3, the positioning module 10 may be a 3D vision camera with image transmission function. The positioning module 10 is in electric connection with a central control system 30. The central control system 30 can be used to control the operation of the positioning module 10; the central control system 30 is, for example, a computer having a storage drive and processor inside.

As shown in FIG. 3, when no bar material appears inside the detection range 11, an alarm system 12 can be triggered to issue an abnormality alarm. The alarm system 12 may be in electric connection with the positioning module 10 and the central control system 30. The central control system 30 is used to control the alarm system 12 to issue an alarm by way of sound and light.

As shown in FIG. 3, the positioning module 10 may be provided in a box 13 in connection with a cooling positive pressure system 14, allowing the box 13 to maintain a set temperature and positive pressure inside, so as to protect the positioning module 10 from high temperature damage and dust pollution in the working environment.

The cooling positive pressure system 14 can, for example, introduce cold air into the box 13 and provide positive pressure. A movable gate (not shown in the figure) is provided on the box 13, and when the positioning module 10 is working, the movable gate of the box 13 is opened.

Referring to FIGS. 1 to 3 again, in step 204, the positioning module 10 is used to carry out a positioning detection on the labeled surfaces 21A to 21F of the bar materials 20A to 20F, such as the side surface or end surface, and the detection result is sent to the central control system 30 for analysis. The present disclosure can detect the single bar material 20A, and can also detect the plurality of bar materials 20A to 20F at the same time. Only one of the bar materials 20A is used as an example below.

If the positioning module 10 is a 3D vision camera with image transmission function, it can capture the image of the labeled surface 21A and send the image to the central control system 30 for analysis.

The positioning detection items include, for example, detecting the spatial coordinates and depth of the labeled surface 21A, and detecting the inclination of the labeled surface 21A and performing trapezoidal correction. Therefore, the labeling problem of the bar material 20A deformed due to thermal expansion and contraction can be overcome.

Referring to FIGS. 2 and 3 again, when the central control system 30 receives a plurality of images, it can judge the position of the labeled surface 21A of the bar material 20A according to the image contents.

Referring to FIGS. 1 to 4, in step 206, the central control system 30 controls a motion module 40 to drive a cleaning module 50 to clean the labeled surface 21A according to the positioning detection result.

As shown in FIG. 2, the motion module 40 is, for example, a robotic arm, which may be a multi-axis motion control articulated robotic arm, which has a working end 41 or a flange. A labeling module 60 is, for example, a nozzle, which can be detachably provided on the working end 41 of the motion module 40.

The motion module 40 is in electric connection with the central control system 30, and can be controlled by the central control system 30 to operate. The motion control module 40 replaces human labor to perform operations in unsuitable high-temperature environments; the motion module 40, for example, may have movement capability or is installed on a mobile carrier.

As shown in FIG. 3, the motion module 40 may be covered with a protective cover 42. The protective cover 42 can withstand a temperature of at least 350 degrees Celsius, for example, to protect the motion module 40 from being damaged in a high-temperature operating environment.

Referring to FIG. 3 again, the cleaning module 50 includes a cleaning brush detachably provided on a working end 41 of the motion module 40 and adapted to clean the dirt on the labeled surface 21A, such as the rust on the labeled surface 21A.

Comparing FIG. 2 with FIG. 3, both the nozzle 61 of the labeling module 60 and the cleaning brush of the cleaning module 50 can be detachably provided on the working end 41 of the motion module 40, namely, they can be replaced with other work tools according to different work contents.

Referring to FIGS. 1, 2 and 4, in step 208, the central control system 30 controls the motion module 40 to drive the nozzle 61 of the making module 60 to perform labeling on the labeled surface 21A according to the positioning detection result. The labeling module 60 controls labeling automation through the central control system 30, which can avoid human labeling errors.

Referring to FIG. 4 again, the cleaning module 50, for example, further includes a pipeline assembly formed by connecting such as a plurality of pipelines, pumps, motors, valve elements and buckets and in electric connection with the central control system 30, a nozzle cleaning assembly 51 and a paint stabilization module 52, where the nozzle cleaning assembly 51 further includes a water bucket 513, a water pipeline 514, a water pump 515 and a direction valve 516; the present disclosure does not limit whether the labeling paint is water-based or oil-based.

The water pump 515 is used to provide high-pressure clean water or solvent to the nozzle 61, and the water bucket 513 contains, for example, water W or solvent. The water pipeline 514 is connected with the nozzle 61 and the water bucket 513. The water pump 515 uses a water pump pipeline 517 to connect the water bucket 513, and is used to pump the water W to the nozzle 61 through the water pipeline 514. The directional valve 516 is provided on the rear ends of a suction pipeline 512 and the water pipeline 514, and used to switch clean water or paint into the nozzle 61 according to the command of the central control system 30.

The nozzle cleaning assembly 51 is in electric connection with the central control system 30, and the central control system 30 is used to control the nozzle cleaning assembly 51 to provide the high-pressure clean water in time to clean the nozzle 61.

In addition, a suction motor 511 is connected to a paint pump 520 and a pain bucket 521 through circulation pipelines 518, 519. The paint bucket 521 contains paint P and is connected to the nozzle 61 through the paint pipeline 522. The paint pump 520 is connected to the paint bucket 521 with the paint pump pipeline 523, and used to pump the paint P to the nozzle 61 through the paint pipeline 522.

The suction pipeline 512, the suction motor 511, the paint pump 520, the circulation pipelines 518, 519, the paint bucket 521 and the paint pipeline 522 are formed into a paint stabilization module 52, and provides a stirring and flow effect to the paint P in the paint bucket 521 (the stirring device is built in the paint bucket 521), preventing the paint P from solidifying; the paint stabilization module 52 is also electrically connected to the central control system 30.

Whereby, the cleaning module 50 is used to clean the rust on the labeled surface of the bar material 20A, and the paint stabilization module 52 can then improve the problem that the mouth of the nozzle 61 is blocked or the high-temperature paint is not easy to solidify.

Referring to FIG. 5, the figure shows a process 200A of a bar material automatic labeling method of the present disclosure. The main difference between the process of the embodiment of FIG. 5 and the process of the embodiment of FIG. 1 is that the process of the embodiment of FIG. 5 increases steps 205, 207. Referring to FIGS. 2 to 5, steps of the process 200A of a bar material automatic labeling method is described.

Step 202: the positioning module 10 is used to detect whether the bar materials 20A to 20F enter the detection range 11.

Step 204: the positioning module 10 is used to perform the positioning detection to the labeled surfaces 21A to 21F of the bar materials 20A to 20F, and then transmit the detection result to the central control system 30 for analysis.

Step 205: if the central control system 30 analyzes the image and determines that the distance of bar material 20A is too far or exceeds the operating range of the motion module 40, the labeling operation of the bar material 20A is then abandoned and the alarm system 12 is triggered to issue an abnormal alarm, and the labeled surface 21B of the next bar material 20B is continued to be detected.

Similarly, if the positioning module 10 detects the labeled surfaces 21A to 21F of the bar materials 20A to 20F at the same time, and the central control system 30 determines that any one or more of bar materials 20A to 20F cannot be labeled, the problematic materials will be skipped, and only processing the materials having a normal position and capable of being labeled is enough.

Step 206: the central control system 30 controls the motion module 40 to drive the cleaning module 50 to clean the labeled surfaces 21A to 21F.

Step 207: the central system 30 controls the nozzle cleaning assembly 51 of the cleaning module 50 to clean the nozzle 61, and step 208 is then executed.

Step 208: the central control system 30 controls the motion module 40 to drive the nozzle 61 of the labeling module 60 to label the labeled surfaces 21A to 21F according to the positioning detection result.

After step 208 is executed, the process can be returned to step 207 according the operation requirements, and the central control system 30 is used to control the nozzle cleaning assembly 51 to clean the nozzle 61, and step 208 is then executed again.

In summary, the present disclosure provides a bar material automatic labeling method. The positioning module overcomes the deformation labeling problem of steel bars due to thermal expansion and cold contraction; the motion module replaces manpower to operate in the unsuitable environment; the labeling module is controlled through the central control system to automate labeling to avoid errors caused by human error; the cleaning module overcomes the labeling failure caused by the paint nozzle and steel bar rust, significantly increasing labeling accuracy and stabilization; and the paint stabilization module overcomes the problem that high-concentration paints suitable for high-temperature materials are easy to solidify and block. The bar material automatic labeling method provided in the present disclosure can improve the risks, operational errors and costs caused by additional protection processes in conventional labeling work. It can significantly reduce labor costs and industrial safety risks, and the quantity and process time of this batch of steel bars can also be recorded during the process to facilitate transfer to subsequent processes and record inquiries while avoiding errors in staff's labeling errors or the misplacement of product production information on paper.

Although the present disclosure has been disclosed in the form of embodiments, it is not intended to limit the disclosure. Anyone with ordinary knowledge in the technical field can make some changes and modifications without departing from the spirit and scope of the disclosure, so the scope of protection of this disclosure shall be subject to the scope of the appended claims.

What is claimed is:

1. A bar material automatic labeling method, adapted to build in a software program and executing the following steps after read by a central control system:
detecting at least one bar material entering a detection range by a positioning module;
performing positioning detection on a labeled surface of said bar material by said positioning module, and sending a detection result to said central control system for analysis;
controlling a motion module to drive a cleaning module to clean said labeled surface by said central control system according to said detection result; and
controlling said motion module to drive a nozzle of a labeling module to label said labeled surface by said central control system according to said detection result.

2. The method according to claim 1, further comprising: abandoning the labeling operation of said bar material and triggering an alarm system to issue an abnormal alarm when said central control system analyzes said detection result and determines that a distance of said bar material is outside the operation range of said motion module in the step of detecting at least one bar material entering a detection range by a positioning module.

3. The method according to claim 1, further comprising: controlling said cleaning module to clean said nozzle by said central control system after the step of controlling a motion module to drive a cleaning module to clean said labeled surface and before the step of controlling said motion module to drive a nozzle.

4. The method according to claim 1, further comprising: transporting said bar material into said detection range with a conveyor belt and then stopping said bar material moving in the step of detecting at least one bar material entering a detection range by a positioning module, where there is at least one bar material on said conveyor belt.

5. The method according to claim 1, wherein said positioning detection comprises detecting the spatial coordinate and depth of said labeled surface, and detecting the inclination of said labeled surface and performing trapezoidal correction.

6. The method according to claim 1, wherein said positioning module is a 3D vision camera, adapted to capture the image of said labeled surface and send said image to said central control system for analysis.

7. The method according to claim 1, wherein said motion module is a robotic arm having a working end, and a cleaning brush of said cleaning module and said nozzle of said labeling module are separately provided on said working end.

8. The method according to claim 1, wherein said cleaning module further comprises a nozzle cleaning assembly and a paint stabilization module, and a directional valve is used to switch said nozzle cleaning assembly and said paint stabilization module to connect to said nozzle.

9. A bar material automatic labeling system, comprising:
a central control system, a software program as claimed in claim 1 stored inside and adapted to execute said software program;
a 3D vision camera, a positioning module as shown in claim 1, in electric connection with said central control system and used to obtain a plurality of images;
a robotic arm, a motion module as shown in claim 1, in electric connection with said central control system and used to install a cleaning brush or a nozzle; and
a pipeline assembly, in electric connection with said central control system, and used to connect said nozzle to provide paint to said nozzle.
